(19) United States
(12) Patent Application Publication
(10) Pub. No.: US 2021/0365511 A1
(43) Pub. Date: Nov. 25, 2021

(54) GENERATION AND DELIVERY OF CONTENT CURATED FOR A CLIENT

(71) Applicant: Holler Technologies, Inc., New York, NY (US)

(72) Inventor: Michael Matloub, Stamford, CT (US)

(73) Assignee: Holler Technologies, Inc., New York, NY (US)

(21) Appl. No.: 17/303,162

(22) Filed: May 21, 2021

Related U.S. Application Data
(60) Provisional application No. 63/028,921, filed on May 22, 2020.

(51) Int. Cl. G06F 16/9535; G06F 16/9538; G06F 16/438

(52) U.S. Cl. CPC G06F 16/9535; G06F 16/438; G06F 16/9538

(57) ABSTRACT

Embodiments described herein relate to a dynamic selection and presentation of recommended content curated for a client. In response to detecting an input (e.g., a text message, a voice input) on a client interface, the system can process the input to derive a series of characteristics of the input. The system can perform a search query using the input characteristics to identify multiple types of recommended content that correspond to the input. The system can update a client interface (e.g., a display on a mobile phone, an application page) to include a set of recommended content to the client. The client can select any of the recommended content included in the client interface to receive more information relating to the selected content on the client interface.

### CROSS-REFERENCE TO RELATED APPLICATIONS

This application claims priority to U.S. Application Ser. No. 63/028,921, filed May 22, 2020, which is hereby incorporated by reference in its entirety.

### BACKGROUND

Individuals can interact with each other in many ways and for many purposes. The individuals in these social interactions can make plans with one another, provide humorous comments to one another, or learn more about one another, for example.

One form of communication with an increasing popularity is electronic communication between individuals on network-accessible devices. For example, individuals can communicate on a text messaging application via mobile devices associated with each individual.

However, in such communications between individuals, various contexts may be discussed. For example, the individuals may discuss making plans to go to a restaurant. However, the individuals may not know of a restaurant that provide a specific food type in a specific geographic area. Further, the individuals may leave the interface facilitating the communication (e.g., a text messaging application) to search for more information relating to a specific context. For instance, the individuals may leave the text messaging application to perform searches for specific restaurants that provide a specific food type.

### SUMMARY

In some embodiments, a computer-implemented method for providing curated recommended content on a client interface is disclosed herein. A client interface is presented on a client device of a client. An input is detected in the client interface. The input includes any of a selection of a search query request icon on the client interface or inputting a message on the client interface. The input is processed to derive characteristics of the input. A search query is performed using the input characteristics to identify at least one entry in a result database that corresponds to the input characteristics. The recommended content related to information included in the at least one entry in the result database is retrieved. The client interface is updated to display the recommended content.

In some embodiments, a non-transitory computer readable medium is disclosed herein. The non-transitory computer readable medium includes one or more sequences of instructions which, when executed by a processor, causes a client device to perform operations. The operations include presenting a client interface on the client device of a client. The operations further include detecting an input on the client interface. The input includes any of a selection of a search query request icon on the client interface or inputting a message on the client interface. The operations further include processing the input to derive characteristics of the input. The operations further include performing a search query using the input characteristics to identify at least one entry in a result database that corresponds to the input characteristics. The operations further include retrieving recommended content related to information included in the at least one entry in the result database. The operations further include updating the client interface to display the recommended content.

In some embodiments, a computing system is disclosed herein. The computing system includes a processor and a memory. The memory has programming instructions stored thereon, which, when executed by the processor, causes the computing system to perform operations. The operations include presenting a client interface on the computing system of a client. The operations further include detecting an input on the client interface. The input includes any of a selection of a search query request icon on the client interface or inputting a message on the client interface. The operations further include processing the input to derive characteristics of the input. The operations further include performing a search query using the input characteristics to identify at least one entry in a result database that corresponds to the input characteristics. The operations further include retrieving recommended content related to information included in the at least one entry in the result database. The operations further include updating the client interface to display the recommended content.

### BRIEF DESCRIPTION OF THE DRAWINGS

Various features of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 illustrate example interfaces on a client device, according to example embodiments.

FIG. 2 is a block diagram of a computing environment, according to example embodiments.

FIG. 3 is an example flow process for retrieving and indexing content retrieved from content sources, according to example embodiments.

FIG. 4 is an example flow process for providing recommended content to a client device, according to example embodiments.

FIG. 5 is an example flow process for receiving and processing selected search result information, according to example embodiments.

FIG. 6 is an example flow process for implementing a service contract, according to example embodiments.

FIG. 7A illustrates a first example set of interfaces illustrating a first example search category selection, according to example embodiments.

FIG. 7B illustrates a second example set of interfaces illustrating a second example search category selection, according to example embodiments.

FIG. 7C illustrates a third example set of interfaces illustrating a third example search category selection, according to example embodiments.

FIG. 8A is an example process for curating a search input using a personality profile of the client, according to example embodiments.

FIG. 8B is an example process for curating a search input using personality profiles of multiple clients, according to example embodiments.

FIG. 9 is a block diagram of an example method for providing recommended content curated for a client on a client device, according to example embodiments.

FIG. 10 is a block diagram illustrating an example of a processing system in which at least some operations described herein can be implemented, according to example embodiments.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

In many instances, individuals communicate with each other electronically via client devices. For example, individuals can transmit messages (e.g., text messages, voice messages) electronically via an application (e.g., a text messaging application, a social media application) executing on devices associated with the individuals.

In these messages, more information may be desired for various contexts. For instance, if a first individual messages “I am hungry,” the first individual may desire more information relating to restaurants in a geographic area near the first individual. As another example, if the first individual messages “I love Drake,” the first individual may desire more information relating to top songs performed by a specific music artist.

One way of retrieving more information about a specific context is to perform a search using keywords on a search engine. However, this generally includes leaving the messaging interface (e.g., text messaging application) and leaving a conversation with other individuals on the client device to perform this search. This may lower user experience, as individuals may be required to move between various applications on a device to communicate with other individuals and perform a search query.

Further, in performing this search, the search results may include results from various contexts. For example, in a search for “hammer,” the results can include links to hardware tools and a music artist. In such an instance, the results that include varying contexts can lower user experience, as the individual may inspect multiple search results to identify a result that corresponds to an intended context for the search. Additionally, performing a search request and inaccurately selecting results from a search can result in inefficient use of computing resources.

In some instances, search result data for an individual can be utilized to modify search parameters in subsequent searches. This can include storing previous search result history of searches provided by the individual. However, storage of such client information can include storing information indicative of the individual (e.g., sensitive data, personally-identifiable information (PII), financial information). Maintaining such information can leave the data at risk of unauthorized access by a malicious entity. Further, maintaining personal data for an individual may not be in accordance with various privacy policies.

To address the shortcomings of current systems outlined above, the present embodiments relate to dynamic selection and presentation of recommended content curated for a client. In response to detection of an input (e.g., a text message, a voice input) on a client interface, the system can process the input to derive a series of characteristics of the input.

The system can perform a search query using the input characteristics to identify multiple types of recommended content that correspond to the input. In some instances, previous messages exchanged in a conversation or a personality profile of a client can be included with the series of characteristics of the input as features utilized in performing the search query and in some instances can narrow the types of recommended content presented to the user.

A client interface (e.g., a display on a mobile phone, an application page) can be updated to include a set of recommended content to the client. For instance, a text messaging application page can include a portion of the page that includes artwork related to various search results of recommended content. The client can select any of the recommended content included in the client interface to provide more information relating to the selected content. For instance, selecting a first instance of recommended content can redirect the client interface to display a third-party webpage or initiate playback of a song performed by a music artist.

The present embodiments can increase user experience by providing a client interface that includes a webpage/application while also providing recommended content relating to inputs provided on the client interface. Rather than being redirected from a webpage/application to perform a search, the present embodiments provide relevant recommended content directly on the client interface while keeping users on the webpage/application. In other words, the search query performed based on the input provided can be a passive search, as inputs (e.g., text messages) provided by the client can be dynamically processed as described herein to generate recommended content relating to the input on the client interface.

Further, the client interface as described herein can increase computing efficiency by providing a client interface that includes both webpage/application content as well as recommended content on the client interface. Rather than the client performing a series of searches and selecting or being presented with inaccurate or irrelevant content, the present client interface provides highly accurate content without directing the client away from the client interface.

Additionally, the present embodiments include retrieving client information and information relating to engagement with recommended content and isolating portions of this data to be used for subsequent processing while maintaining security of the client data. Particularly, the system can parse obtained client data to identify all data that includes information indicative of the client (e.g., client data, financial data, geographic data) and perform a first action with the data (e.g., store the information in a first database for use in generation of a personality profile, delete the data). Other data that does not include the information indicative of the client can be stored in a second database that can aggregate data from multiple clients and derive insights into the data. Example insights can include engagement with various types of recommended content, partner content providers with greatest engagement, a duration of engagement with content, applications with greatest interaction with the recommended content, etc.

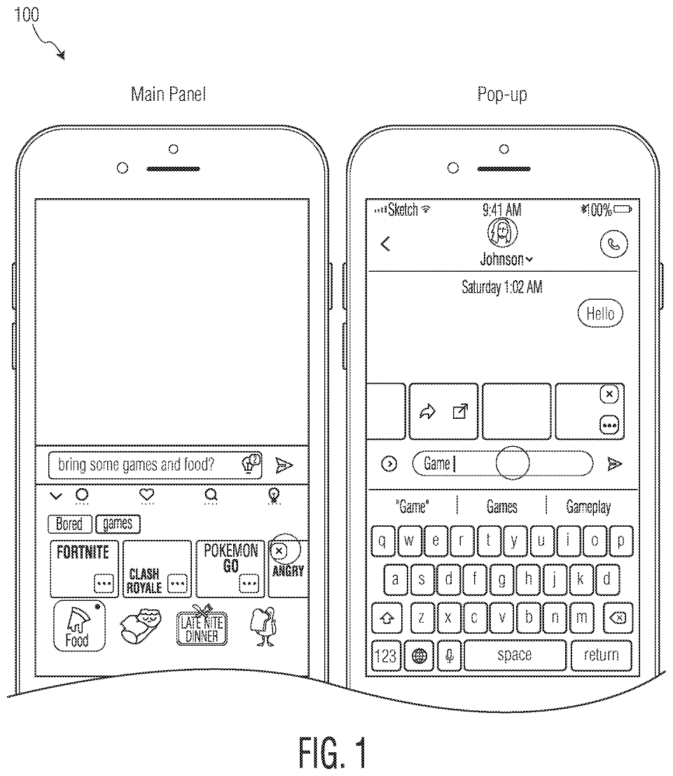

FIG. 1 illustrate example interfaces 100 on a client device. As shown in FIG. 1, the client device can execute an application on the device, such as a text messaging application, for example. The client device can include any network-accessible device, such as a smartphone, tablet, computer, wearable device, etc.

While the present embodiments describe a text messaging application and text messages as inputs as an illustrative example for implementing processes as described herein, the present embodiments are not limited to such an example. For instance, the client device can execute a social media application and can provide curated content on the social media application. As another example, the client device can include a smart speaker that can obtain voice input of the client and provide curated content to the client via audio output on the smart speaker.

As shown in FIG. 1, the interface can depict a text messaging application that is capable of communicating messages between parties. As an example, a text can include “bring some games and food?” In this example, the system, as described in greater detail below, can parse this input to derive the term “game” as relevant search criteria and process the criteria to provide recommended content. For example, the recommended content can include links/artwork of popular video games, stickers relating to games that can be added to the text conversation, etc. The interface can display the search results in any of various arrangements, such as by most highly rated content, for example.

As noted below, the system can process prior text information (e.g., previous messages exchanged between the clients), user profile information, relevance/ratings of the retrieved search results, etc., to curate recommendations for the client. In some embodiments, personality profiles for clients can be generated and content can be presented to the user based on the personality profiles for the users involved in a text message-based conversation.

In other embodiments, user profile information of multiple users (e.g., each user in a group text message chat) can be utilized to derive content that is relevant to all users in the group. For example, if the term “game” is relevant search criteria and if all user profiles have previously purchased/downloaded/engaged with mobile video games of a specific genre (e.g., action games), the recommended content can include a series of action games that include a highest user rating.

The recommended content on the interface can be presented as artwork, thumbnails, trailers depicting the content, a video, etc. The recommended content can include links to access the content (e.g., a link to an online store to access/purchase the content). The recommended content can also include sharing functionality such as allowing for the content to be shared on various applications (e.g., social media applications).

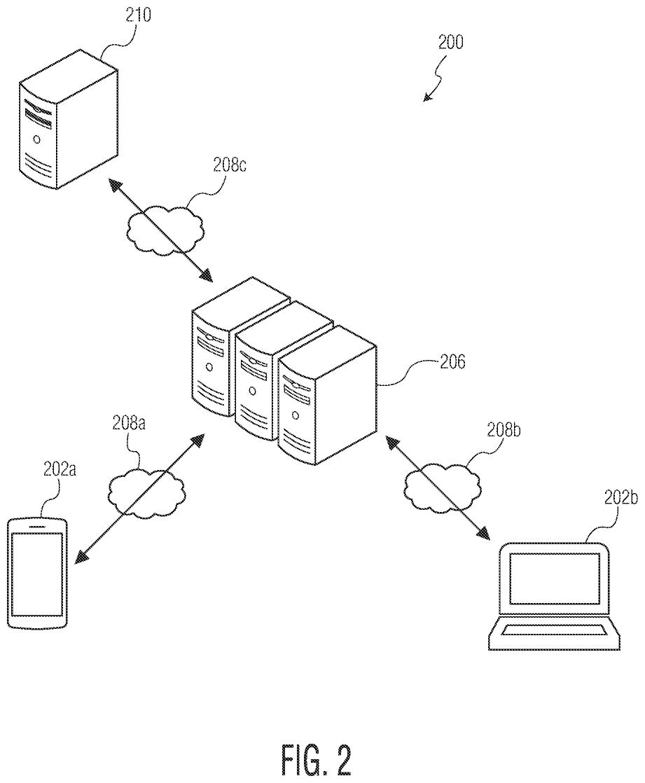

FIG. 2 is a block diagram of an example environment 200 in which the present embodiments can be implemented. The environment 200 can include one or more client devices 202a-b. Each client device 202a, 202b can include a network-accessible device (e.g., a smartphone, tablet, computer) capable of presenting a client interface to a client and communicating information with network-accessible server system 206 via networks 208a-b.

The environment 200 can include a network-accessible server system 206. The network-accessible server system 206 can include one or more computing devices (e.g., servers) capable of storing information and performing processing tasks as described herein.

The devices included in the environment 200 can communicate via networks 208a-c. The network(s) 208a-c can include personal area networks (PANs), local area networks (LANs), wide area networks (WANs), metropolitan area networks (MANs), cellular networks, the Internet, etc. Additionally or alternatively, the network-accessible server system 206 can be communicatively coupled to devices device(s) in the environment 200 over a suitable wired/wireless communication protocol.

The network-accessible server system 206 can communicate with a third-party server 210. The third-party server 210 can include a device associated with a third party (e.g., a content provider, a video streaming server, a game platform device). The network-accessible server system 206 can connect with third-party server 210 via an application programming interface (API), a plugin, etc. The network-accessible server system 206 can retrieve various types of content from third-party server 210 that can be included as recommended content as described herein.

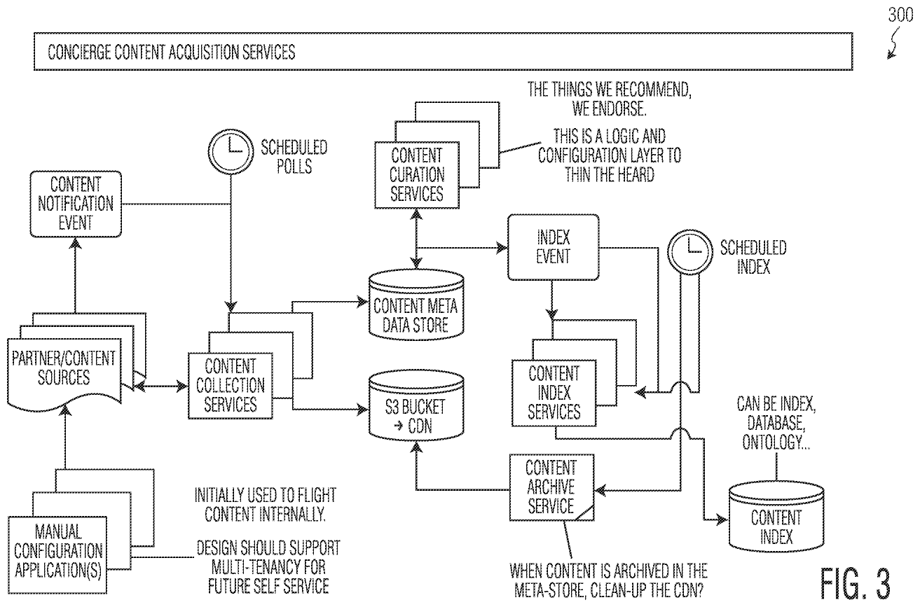

FIG. 3 is an example flow process 300 for retrieving and indexing content retrieved from content sources. As shown in FIG. 3, the system can include a content collection service that can retrieve content from partner/content sources. Example partner/content sources include video streaming providers, music streaming providers, game platforms, video game providers, art platforms, etc. In some embodiments, the partner/content sources can only include providers that have agreed to provide content to the content collection service.

The system can include a manual configuration application that can be used to provide content internally. The design of the manual configuration application can support multi-tenancy for self-service.

The content collection service can obtain a plurality of content, parse the content, and store the content. For instance, a content meta data store can parse the content by data type (e.g., artwork, link to service, thumbnail).

The content curation services can be utilized to inspect inputs to derive recommended content curated for the user. The content curation services can use various rules, logic, engines, models, machine learning, neural networks, artificial intelligence, etc., to derive content recommended for the user.

The content curation service can inspect the input, previously-provided inputs by a user/group of users, personality profiles of user(s), user account information, etc., to derive recommended content. The recommended content can include content that is most relevant to the input provided, content with a highest user rating, content most relevant to the user account information, or any combination thereof.

The input, recommended content, and any engagement with the content can be indexed and maintained by the content index. Information stored in the context index can be utilized to determine engagement with various recommended content and to improve future instances of recommending content.

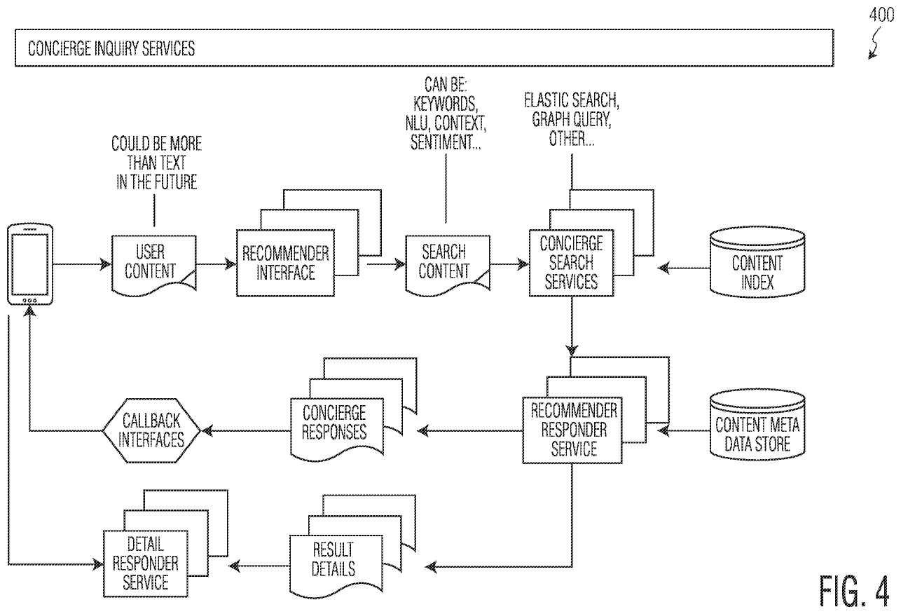

FIG. 4 is an example flow process 400 for providing recommended content to a client device. The client device can provide user content (e.g., text, voice, drawings) and process the user content to derive search content from the user content. The search content can include terms to be used in the search for recommended content. Example types of search content can include keywords, natural-language understanding (NLU), context, sentiment, etc.

A search service can perform a search using the search content. Example search types can include querying database(s), elastic searches, graph queries, etc. The search service can also include information from the content index to derive results that are accurate.

The search results can include results of varying contexts. For example, the term “Drake” can refer to either a music artist or a university. The results of varying contexts can be provided to the client and the user can select the desired context. In some instances, the system can derive an estimated context for the search results. For example, if prior text message refers to music, the system can determine that a search for the term “Drake” refers to a musical artist. The estimated context can include confidence levels and the recommended content can be determined by the confidence level.

The system can retrieve result details and arrange the results to be presented to the client on the client device. In instances in which a confidence level about the intended category is below a threshold, the system can display all possible categories (e.g., Drake the musician, Drake the university). The most likely candidate can be positioned in the place on the screen most likely to be selected within the selection of categories (e.g., middle position). In instances in which the confidence level about the intended category is above the threshold, the system can prioritize the selected category and provide various subcategories (e.g., merchandise, songs, albums, concerts). The client device can provide any selection on the client device and the system can provide the selected content to the client device.

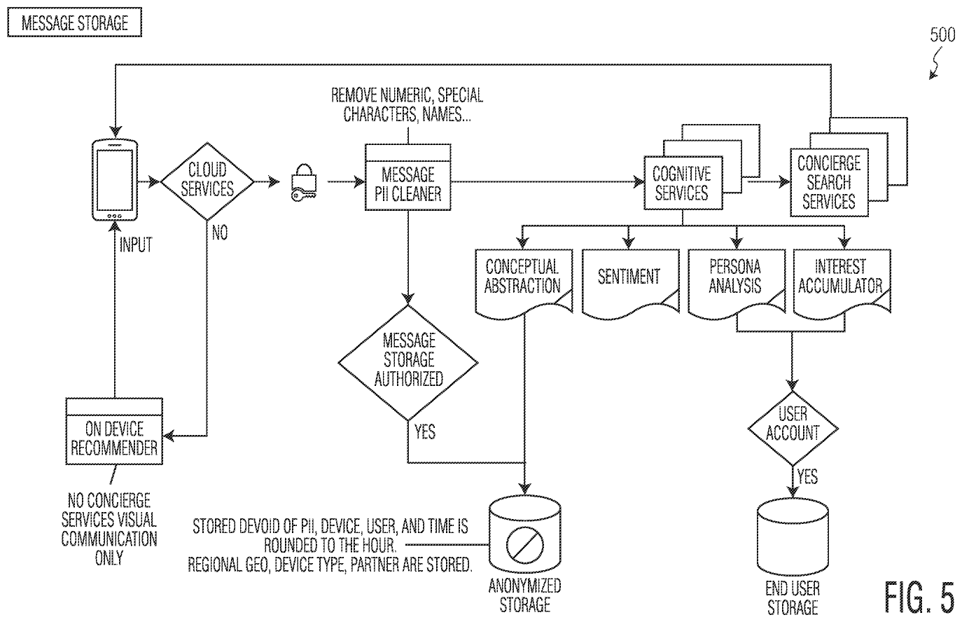

FIG. 5 is an example flow process 500 for receiving and processing selected search result information. The client device can provide a selection of recommended content (or any other input) to the system. For instance, the selection can include a request to redirect the user to selected recommended content.

In some embodiments, the client device can include on-device recommendation engine(s) capable of providing recommended content. For instance, the on-device recommendation engine can provide visual recommended content (e.g., virtual stickers) by the client device. The on-device recommendation engine(s) can operate when the client device is offline or unable to connect to the system.

The system can include a message identifiable information cleaner that can parse obtained data and remove information indicative of a client. For example, the message identifiable information cleaner can parse names, device information, client identifiers (e.g., government-issued identifiers), financial information, a time of providing the content, etc. The parsed information can be deleted and the remaining information can be stored and utilized to gain insights into the selections provided by the clients. The cleaned data can be stored in an anonymized storage responsive to determining that the message storage is authorized. In some embodiments, the cleaned data will not include for example personally identifiable information, device information, and particular user information. The cleaned data can include for example regional location and device type (e.g., manufacturer, model, software version).

The cleaned data can be processed through cognitive services and/or concierge search services to process the data and derive insights into the data. For example, the cognitive services can include deriving contextual abstraction of the data, a sentiment in the data, a persona analysis, an interest accumulator, etc. Various data relating to a user can be stored in a user account and stored in end user storage.

The system can derive various insights into recommended content based on data obtained from multiple client devices. For example, client content interaction information can be parsed to remove personally-identifiable information and be aggregated by data type for processing. This information can be processed to generate analytics relating to engagement with content types, partner content provider engagement levels, a demand for various content types, revenues derived from various content, user ratings of content, etc. An operator can inspect the analytics to update search parameters, modify search rules, add a higher priority on specific partner content providers, etc., to enhance user experience and an accuracy in recommended content. The analytics can improve search efficiency and accuracy and promote partner content providers with higher quality content (e.g., providers with greater engagement or user rating).

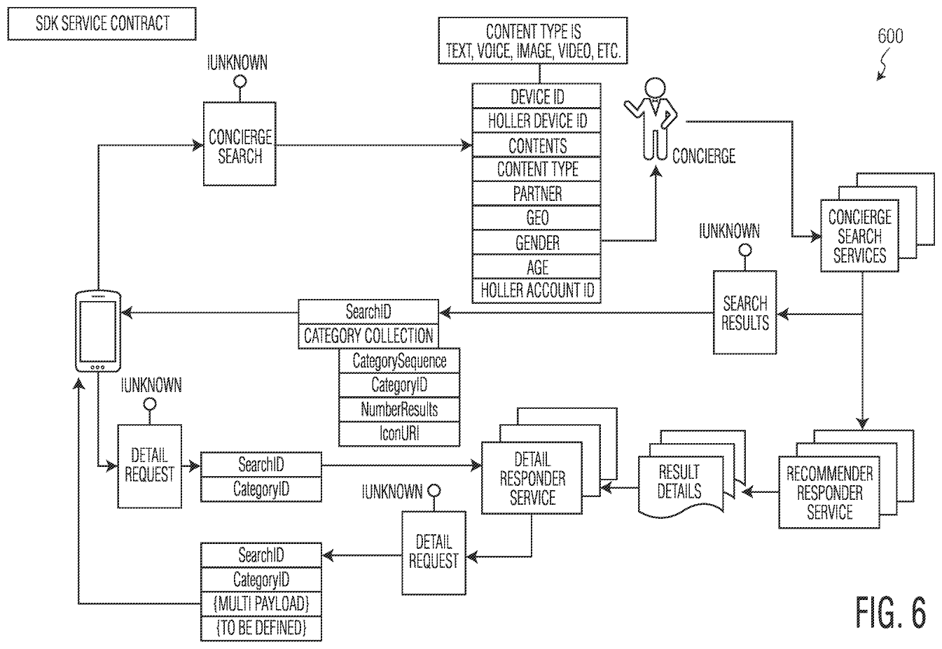

FIG. 6 is an example flow process 600 for implementing a service contract. As shown in FIG. 6, a user device can provide a detail request that can be parsed to derive a search ID and a category ID of the search input. The responder service can process the detail request to derive a detail response. The responder service can retrieve relevant result details and recommender response services to provide curated results for the client. The detail response can include a search ID, a category ID, a payload, etc.

In some embodiments, the user device can provide a concierge search to the system that can include any of a variety of input types (e.g., text, voice, image, video). The concierge search can include data such as a device ID, contents, content type, partner, geographic information, gender, age, account ID, etc. The system can process the concierge search using concierge search services to derive search results curated for the client. The search results can include a search ID, a category collection, a category sequence, a category ID, a number of results, an icon URI, etc.

As noted above, a search result can include a series of recommended content curated for the client and can be provided to the client. For example, the search results can be provided as an interface on a client device.

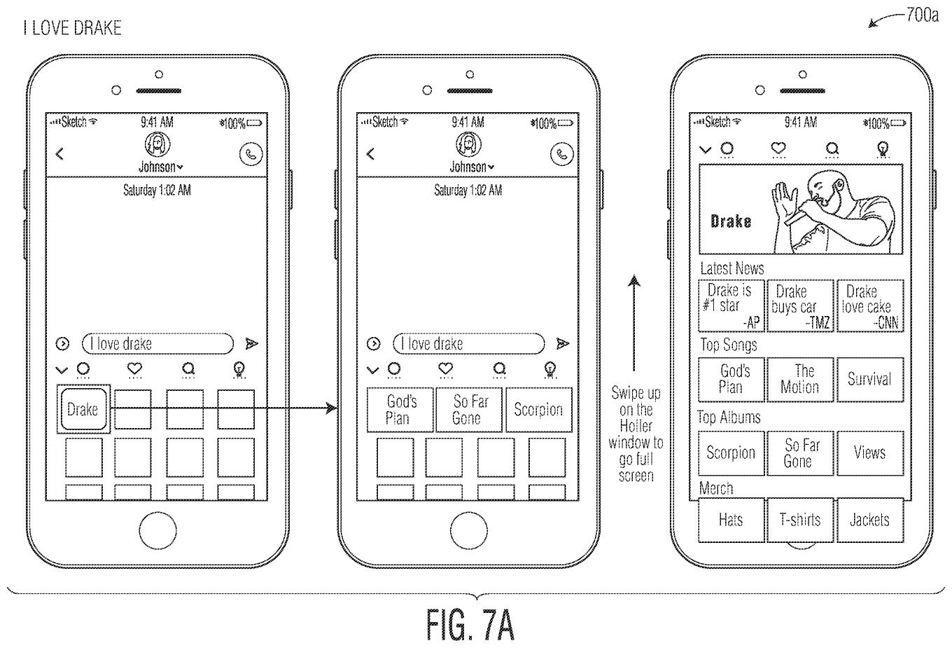

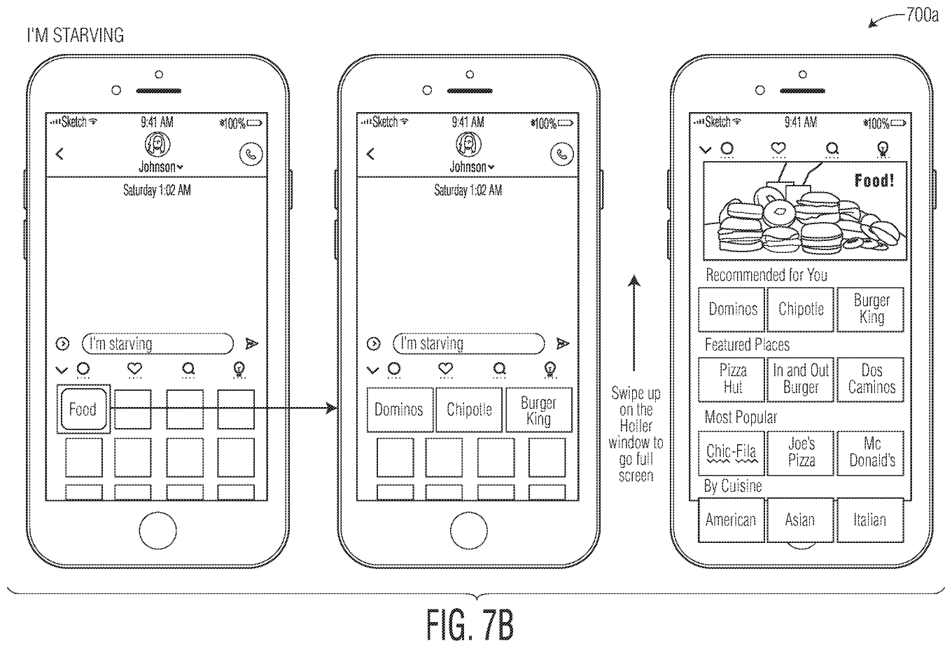

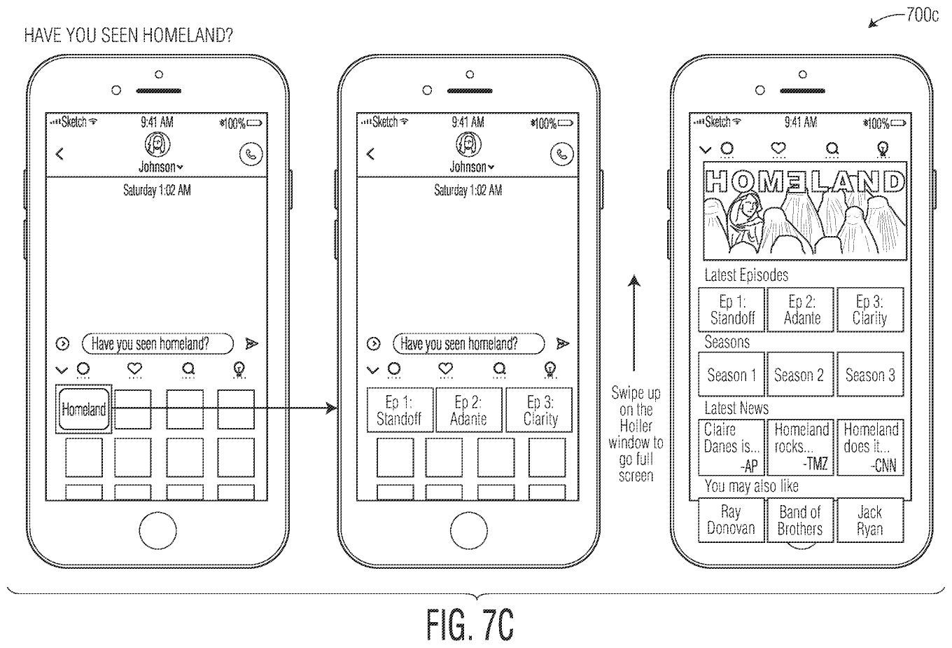

FIGS. 7A-7C illustrate interfaces 700a-c illustrating example search result category selections. FIG. 7A illustrates a first example set of interfaces 700a illustrating a first example search category selection. As an example, an input can include a text message from a client that includes the text “I love Drake.” The input can be processed to derive keywords (e.g., “Drake,” “love”) and derive contexts, sentiments, etc., in the keywords. For example, the term “Drake” can be compared against term repositories to derive that this term can relate to any of a music artist, a university, etc. Further, the terms can be processed to derive a sentiment (e.g., the term “love” relates to a positive sentiment to the term “Drake”).

The system can retrieve search results of potential contexts in which the input refers. For example, the search results can provide relevant information relating to the music artist “Drake” in response to the input “I love Drake.” The system can provide recommended content relating to this category, such as most popular songs by the artist, news articles, top albums, links to merchandise, links to purchase concert tickets, etc. The types of information and the order of the information presented on the client interface can be ordered based on a rating of the content, a relevance to the client account or previous inputs, etc.

The search results can include multiple levels that allow for a user to select and access various types of content. For example, upon selecting the context (e.g., “Drake”), the interface can display links (and associated artwork) for a series of most popular songs by the artist. The client can select one of the links for access to the song or the client can perform another action (e.g., swipe, select a button) to view more categories relating to the search result. If the client performs the other action (e.g., swipe up), the interface can show a series of content types, related artwork/audio/video, etc.

FIG. 7B illustrates a second example set of interfaces 700b illustrating a second example search category selection. The second example search category selection can include detecting an input of “I'm starving.” In this example, the input can be processed to derive a sentiment of hunger by the client and can determine that recommended content can include a series of restaurants/food items/food types/etc.

As shown in FIG. 7B, the interfaces 700b can display a set of recommended restaurants that can deliver food items to the client. The recommended restaurants can be provided on the interface based on any of a relevance of a restaurant to the user, a rating of the restaurant, account history of the client, etc. The user can select a link to a recommended restaurant or perform another action (e.g., swipe up) to view more information relating to the search result. Additional information can include recommended restaurants, featured places, most popular restaurants, cuisine types, etc.

FIG. 7C illustrates a third example set of interfaces 700c illustrating a third example search category selection. As shown in FIG. 7C, the input can include the text “have you seen Homeland?” The system can process the input to determine that recommended content is to relate to a television program associated with the term “Homeland,” and provide relevant links to episodes, seasons, news, other recommended content, etc.

As noted above, the present embodiments can relate to generation of a personality profile associated with a client and utilizing the personality profile in generation of curated content for a client.

The system can obtain various information relating to a client and develop a personality profile based on this information. For example, the system can process prior inputs provided by a client, engagement with recommended content, interests, sentiments, purchasing history, etc., and develop a profile specific to the client.

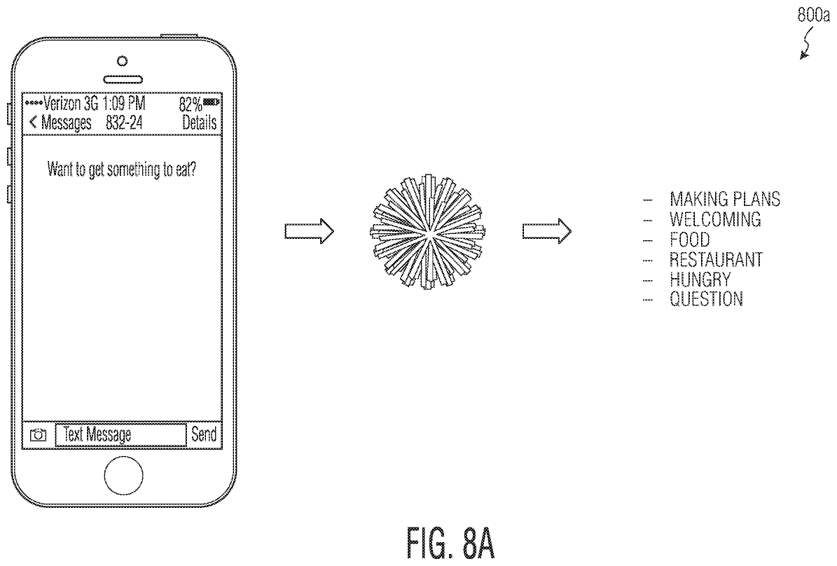

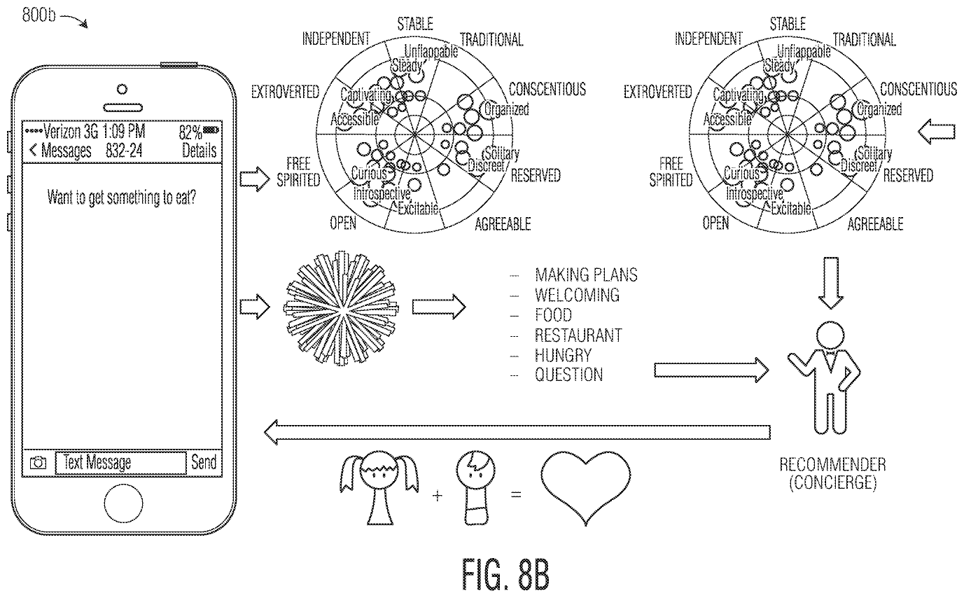

FIG. 8A is an example process 800a for curating a search input using a personality profile of the client. As shown in FIG. 8A, the client device can obtain an input (e.g., “want to get something to eat?”). The system can first derive aspects of the input. The system can also process the input using the personality of the client to provide search results that are most curated to the client. For example, the search criteria can include a request to make plans, a welcoming sentiment, food-related context, a request for a restaurant recommendation, a hungry client, a question being posed, etc.

The personality profile can be utilized to increase user engagement in developing recommending content. For example, the system can take into account favorites of a user, user content, a wallet (e.g., saving offers, content, points accumulated), premium content, etc., to develop a personality profile. Further, a client can control aspects of their personality profile, such as privacy settings, interest categories, obtain points for sharing content, extended conversional functionality, etc.

In some embodiments, the system can include a language interpretation engine that can process inputs and client information to derive client-specific input characteristics. For example, the language interpretation engine can derive what the input is about (e.g., a context of the input), how the client feels about it (e.g., a sentiment), what the client is attempting to accomplish, a style of the user, etc.

FIG. 8B is an example process 800b for curating a search input using personality profiles of multiple clients. As noted above, inputs can be generated based on interactions (e.g., text message conversations) between clients. For example, such an interaction can include a group text message conversation between a group of clients. Further, the system can generate personality profiles for any clients of the group of clients. The personality profiles can be utilized to curate recommended content for all clients involved in the interaction.

As an illustrative example, two clients can communicate via text in an application (e.g., a messaging application, a dating application, a social media application). In this example, a first message can include “want to get something to eat?” This input can be processed to derive various characteristics of the input (e.g., making plans, welcoming sentiment, food-related, restaurant context, hunger emotion, a question posed). In some embodiments, prior messages by the clients can be processed to gain further insights into the input. The system can process the input and the characteristics to derive recommend content curated to both clients communicating in the application. For example, the system can determine that both clients have an interest in Italian cuisine. The interfaces on any client device of the clients can provide recommended content that includes Italian restaurants that is within a threshold geographic region of both clients. The recommended content can include links to various information, such as a link to make a reservation at the restaurant, a link to a menu, popular food items, a rating of the restaurant, recommended food items, etc.

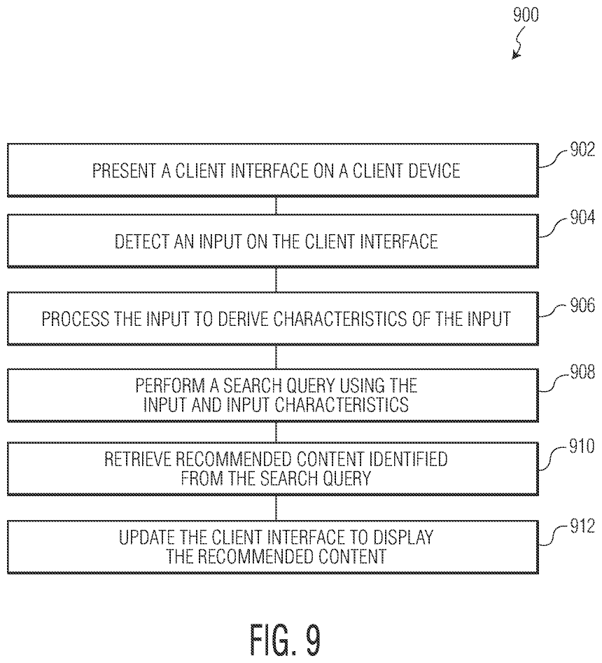

FIG. 9 is a block diagram 900 of an example method for providing recommended content curated for a client on a client device. The method can include presenting a client interface on the client device (block 902). The client interface can include a display/webpage/application page on the client device. For example, a client interface can be part of an application (e.g., a text messaging application, a social media application, a dating application) executing on the client device.

In some embodiments, presenting the client interface can include updating a portion of the client interface to include recommended content. For example, a recommended content icon can be included on the client interface that, when selected, can provide recommended content or insights to the client. As another example, the client interface can include a series of stickers that can be added to a text message that correspond to detected recommended contexts in a conversation.

The method can include detecting an input on the client interface (block 904). Detecting the input can include dynamically identifying inputs (e.g., text, voice) that can be processed to derive recommended content in the input. For example, the input can include a text message of “I am hungry.” In some embodiments, detecting the input can include detecting selection of a recommended content icon.

The method can include processing the input to derive characteristics of the input (block 906). This can include parsing the input to derive various aspects of the input, such as, for example, a sentiment, keywords, context, a geographic area, whether the input is a question, etc. The input and the characteristics of the input can be utilized to derive search results that are curated to the user.

In some embodiments, the system can utilize a series of inputs (e.g., a text message conversation) to derive further insights into an input. For example, if a first input is a text message indicating “I am hungry,” and previous inputs (e.g., text messages) indicate that the client was talking about desiring pizza with another client, the system can parse the text messages and identify that a recommended food item type to provide to the client should be pizza.

In some embodiments, the method includes retrieving client personality profile data. The client personality profile can include a set of interests, content engagement history, input history, etc., that provides insights into the profile of the client in interacting with the system. For instance, if the client repeatedly provides inputs that are happy/uplifting, the system can derive that the client is likely to provide other happy/uplifting inputs. As another example, if the client engages with songs of a specific genre, the client may more likely engage with other songs in that genre in future instances of providing recommended content. The personality profile may be utilized in deriving the recommended content for the client.

The method can include performing a search query using the input and the input characteristics (block 908). This can include comparing the input/input characteristics with a series of entries in one or more tables/databases/etc., to identify entries that correspond to the inputs. For example, performing a search query for the input “I am hungry” can result in identifying entries relating to food items within a geographic distance of the client, such as restaurants that include a favorite food item type of the client or have a specific user rating, for example. The system can use any of a variety of search techniques to derive the recommended content for the client.

In some embodiments, the search query involves incorporating personality profiles of any number of clients associated with the input. As a first example, a client input can include an input provided by the client. As another example, an input can include a text message exchanged between a group of clients. Personality profiles of multiple clients can be utilized to generate content that corresponds to the personality profile of the clients.

The method can include retrieving recommended content detailed information (block 912). This can include arranging information relating to the recommended content derived from the search query to be provided to the client. For example, for an input of “I love Drake,” a search result can include a music artist. In this example, the system can retrieve various types of detailed content, such as top songs, links to albums, merchandise, concert tickets, news, etc., relating to the music artist. In some embodiments, the recommended content can be arranged by greatest popularity/engagement or arranged by relevance to the personality profile of the user.

The method can include updating the client interface to display the recommended content (block 914). The client interface can include one or more contexts that relate to various search results that are curated for the client. For example, the contexts can include different restaurants or food types if the input is “I am hungry.”

The client interface can include a set of recommended content that includes links to content. For example, if recommended content displays top songs by a music artist, the client can select a link on a top song to be redirected to a webpage/application to share/play the selected song. The client can take an action (e.g., swipe on a touchscreen) to view more detailed information about the recommended content.

In some embodiments, the method can include detecting a selection of a link for recommended content on the client interface. Responsive to this selection, the client device can retrieve a webpage/application associated with the link and perform a subsequent action (e.g., redirect the client to a third-party website, play a song).

In another embodiment, a method can include retrieving client information, input information, and recommended content interaction information (e.g., client engagement with recommended content) to implement a data processing and cleaning process. The retrieved information can be parsed into multiple categories. For example, a first category can include data with all personally-identifiable data (e.g., client data, financial information, geographic information) removed and a second category can include data that includes the personally-identifiable data. The first category of data can be aggregated over time and used to derive insights into engagement with recommended content. For example, the insights can include determining content with greatest engagement, types of content that is engaged with more often, an accuracy of contexts of recommended content, etc. An operator can view analytics relating to the first category (e.g., the cleansed data) in an analytics dashboard to view various characteristics, such as partner content providers with high engagement, for example.

In another method, the method can include generating a personality profile for a client. A personality profile can utilize previous interactions with recommended content by a client and characteristics of inputs provided by the client to derive a profile relating to interests, common sentiments, input style (e.g., uplifting, sarcastic), recommended content types with a greatest engagement, etc. The system as described herein can process the input using the personality profile to retrieve recommended content that takes into account the personality profile of the user. For example, if the personality profile indicates that a client prefers Italian food at a restaurant near the client, the recommended content for the input “I am hungry” can recommend delivery of food from an Italian restaurant. A personality profile can be updated/modified/deleted by the client.

In some embodiments, the method can include performing a search query taking into account multiple client personality profiles. For instance, if an input is retrieved from a conversation between clients, recommended content can be derived based on the multiple personality profiles of the clients.

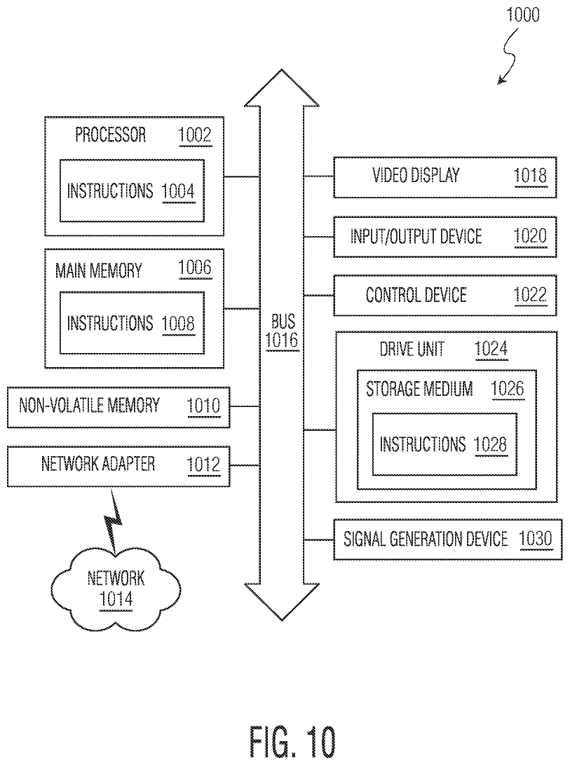

FIG. 10 is a block diagram illustrating an example of a processing system 1000 in which at least some operations described herein can be implemented. The processing system 1000 may include one or more central processing units (“processors”) 1002, main memory 1006, non-volatile memory 1010, network adapter 1012 (e.g., network interface), video display 1018, input/output devices 1020, control device 1022 (e.g., keyboard and pointing devices), drive unit 1024 including a storage medium 1026, and signal generation device 1030 that are communicatively connected to a bus 1016. The bus 1016 is illustrated as an abstraction that represents one or more physical buses and/or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1000 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1000.

While the main memory 1006, non-volatile memory 1010, and storage medium 1026 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the processing system 1000.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the one or more processors 1002, the instruction(s) cause the processing system 1000 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following embodiments.

1. A computer-implemented method for providing curated recommended content on a client interface, the computer-implemented method comprising:
presenting the client interface on a client device of a client, the client interface corresponding to a text messaging application executing on the client device;
detecting an input on the client interface, the input comprising any of a selection of a search query request icon on the client interface or inputting a message on the client interface;
processing the input to derive characteristics of the input;
performing a search query using the input characteristics to identify at least one entry in a result database that corresponds to the input characteristics;
retrieving the recommended content related to information included in the at least one entry in the result database; and
updating the client interface to display the recommended content.

2. The computer-implemented method of claim 1, further comprising:
detecting a selection of a first instance of recommended content on the client interface; and
modifying the client interface to present the first instance of recommended content, wherein presenting the first instance of recommended content includes any of redirecting the client interface to a new webpage, outputting an audio file, and outputting a video file.

3. The computer-implemented method of claim 2, further comprising:
retrieving the input, input characteristics, selection of the first instance, and any engagement with the first instance of recommended content; and
processing the input, input characteristics, selection of the first instance, and any engagement with the first instance of recommended content to identify a first subset of data comprising information indicative of the client and a second subset of data that includes information not indicative of the client.

4. The computer-implemented method of claim 3, further comprising:
processing the first subset of data to derive a personality profile of the client, wherein the personality profile is utilized in performance of the search query; and
deleting the first subset of data in the client information database.

5. The computer-implemented of claim 3, further comprising:
aggregating a series of data from multiple clients that includes information that is not indicative of any clients in a data analysis database;
generating a set of analytics relating to any of client engagement with the recommended content, the input characteristics, input type, and sentiments included in inputs; and
presenting the set of analytics on an analytics dashboard on an operator device.

6. The computer-implemented method of claim 3, further comprising:
storing the first subset of data into a client information database maintaining client information for generation of a personality profile of the client; and
storing the second subset of data in a data analysis database for subsequent processing.

7. The computer-implemented method of claim 1, wherein processing the input to derive the characteristics of the input further comprises:
parsing the input to identify a series of terms in the input;
deriving a number of contextual keywords from the series of terms that are indicative of various contexts that the input relates; and
deriving a number of sentimental keywords from the series of terms that are indicative of a sentiment of the input, wherein the number of contextual keywords and the number of sentimental keywords are utilized in performance of the search query.

8. The computer-implemented method of claim 1, further comprising:
retrieving a series of previous interactions relating to the client; and
processing the series of previous interactions to derive a set of previous interaction keywords indicative of contexts of the series of previous interactions, wherein the set of previous interaction keywords are utilized in performance of the search query.

9. The computer-implemented method of claim 1, further comprising:
identifying a number of types of recommended content identified from the search query; and
ordering the types of recommended content based on any of a relevance to the input, a relevance to a client profile, a relevance to any of a previous set of messages, a rating corresponding each type of recommended content, wherein the display of the recommended content is arranged based on the ordering of the types of the recommended content.

10. The computer-implemented method of claim 1, further comprising:
retrieving a set of previously-presented client information that includes any of characteristics of previous inputs provided by the client, engagement levels with various types of recommended content, previously-derived sentiments included in previously-provided inputs, and client-specified interests; and
generating a personality profile for the client, wherein the personality profile is utilized in performance of the search query.

11. The computer-implemented method of claim 1, further comprising:
retrieving a personality profile generated for the client based on a set of previously-presented client information for the client.

12. The computer-implemented method of claim 11, wherein performing the search query using the input characteristics to identify the at least one entry in a result database that corresponds to the input characteristics comprises:
using the personality profile with the input characteristics to identify the at least one entry.

13. A non-transitory computer readable medium comprising one or more sequences of instructions which, when executed by a processor, causes a client device to perform operations comprising:
presenting a client interface on the client device of a client, the client interface corresponding to a text messaging application executing on the client device;
detecting an input on the client interface, the input comprising any of a selection of a search query request icon on the client interface or inputting a message on the client interface;
processing the input to derive characteristics of the input;
performing a search query using the input characteristics to identify at least one entry in a result database that corresponds to the input characteristics;
retrieving recommended content related to information included in the at least one entry in the result database; and
updating the client interface to display the recommended content.

14. The non-transitory computer readable medium of claim 13, further comprising:
detecting a selection of a first instance of recommended content on the client interface; and
modifying the client interface to present the first instance of recommended content, wherein presenting the first instance of recommended content includes any of redirecting the client interface to a new webpage, outputting an audio file, and outputting a video file.

15. The non-transitory computer readable medium of claim 13, wherein processing the input to derive the characteristics of the input further comprises:
parsing the input to identify a series of terms in the input;
deriving a number of contextual keywords from the series of terms that are indicative of various contexts that the input relates; and
deriving a number of sentimental keywords from the series of terms that are indicative of a sentiment of the input, wherein the number of contextual keywords and the number of sentimental keywords are utilized in performance of the search query.

16. The non-transitory computer readable medium of claim 13, further comprising:
retrieving a series of previous interactions relating to the client; and
processing the series of previous interactions to derive a set of previous interaction keywords indicative of contexts of the series of previous interactions, wherein the set of previous interaction keywords are utilized in performance of the search query.

17. The non-transitory computer readable medium of claim 13, further comprising:
identifying a number of types of recommended content identified from the search query; and
ordering the types of recommended content based on any of a relevance to the input, a relevance to a client profile, a relevance to any of a previous set of messages, a rating corresponding each type of recommended content, wherein the display of the recommended content is arranged based on the ordering of the types of the recommended content.

18. The non-transitory computer readable medium of claim 13, further comprising:
retrieving a set of previously-presented client information that includes any of characteristics of previous inputs provided by the client, engagement levels with various types of recommended content, previously-derived sentiments included in previously-provided inputs, and client-specified interests; and
generating a personality profile for the client, wherein the personality profile is utilized in performance of the search query.

19. The non-transitory computer readable medium of claim 13, further comprising:
retrieving a personality profile generated for the client based on a set of previously-presented client information for the client; and
using the personality profile with the input characteristics to identify the at least one entry.

20. A computing system, comprising:
a processor; and
a memory having programming instructions stored thereon, which, when executed by the processor, causes the computing system to perform operations comprising:
presenting a client interface on the computing system of a client, the client interface corresponding to a text messaging application executing on the computing system;
detecting an input on the client interface, the input comprising any of a selection of a search query request icon on the client interface or inputting a message on the client interface;
processing the input to derive characteristics of the input;
performing a search query using the input characteristics to identify at least one entry in a result database that corresponds to the input characteristics;
retrieving recommended content related to information included in the at least one entry in the result database; and
updating the client interface to display the recommended content.
